(19) United States
(12) Patent Application Publication
(10) Pub. No.: US 2026/0140230 A1
(43) Pub. Date: May 21, 2026

(54) OBSTACLE RECOGNITION DEVICE, OBSTACLE RECOGNITION METHOD, AND STORAGE MEDIUM

(71) Applicant: TOYOTA JIDOSHA KABUSHIKI KAISHA, Toyota-shi (JP)

(72) Inventors: Ryusuke UMEYAMA, Susono-shi (JP); Shoichi Hayasaka, Atsugi-shi (JP); Shinya Ohkawa, Matsuyama-shi (JP)

(73) Assignee: TOYOTA JIDOSHA KABUSHIKI KAISHA, Toyota-shi (JP)

(21) Appl. No.: 19/357,436

(22) Filed: Oct. 14, 2025

(30) Foreign Application Priority Data
Nov. 19, 2024 (JP) 2024-201538

(51) Int. Cl. G01S 7/41; G01S 13/04; G01S 13/931

(52) U.S. Cl. CPC G01S 7/415; G01S 13/04; G01S 13/931

(57) ABSTRACT

An obstacle recognition device acquires information about a target that is present in front of a vehicle and detected by a millimeter-wave radar mounted in the vehicle from the millimeter-wave radar, and executes, based on the information about the target, a first determination as to whether the target is present in a first area and a second determination as to whether the target determined to be present in the first area in the first determination is detected by the millimeter-wave radar when the target is present in a second area. The obstacle recognition device discards the information about the target in a case where the target is determined to be present in the first area in the first determination and the target is determined to be not detected by the millimeter-wave radar when the target is present in the second area in the second determination.

### CROSS-REFERENCE TO RELATED APPLICATION

This application claims priority to Japanese Patent Application No. 2024-201538 filed on November 19, 2024. The disclosure of the above-identified application, including the specification, drawings, and claims, is incorporated by reference herein in its entirety.

### BACKGROUND

### 1. Technical Field

The present disclosure relates to an obstacle recognition device, an obstacle recognition method, and a storage medium.

### 2. Description of Related Art

Japanese Patent No. 6473685 (JP 6473685 B) discloses an autonomous driving vehicle that autonomously drives at a preset traveling speed on a preset traveling route in a mine. In addition, JP 6473685 B discloses that the millimeter-wave radar has a characteristic that it is difficult to identify whether the detected object is a road surface unevenness, a fallen rock, or a manned vehicle. Therefore, in the autonomous driving vehicle described in JP 6473685 B, a millimeter-wave radar and a laser radar (light detection and ranging: LiDAR) are used in combination.

### SUMMARY

The LiDAR is weak in a bad environment, such as dust, rain, fog, or backlight. Therefore, in order to ensure a robustness to an environment, it is preferable to improve the recognition accuracy of the millimeter-wave radar alone (that is, to improve the recognition accuracy of the obstacle using solely the millimeter-wave radar without using the LiDAR).

On the other hand, in a case where solely the millimeter-wave radar is used without using the LiDAR, the millimeter-wave radar recognizes a reflection wave from a near road surface unevenness, a small stone, and the like on an unpaved road as a target (obstacle). This is because the reflection wave from the road surface unevenness, the small stone, and the like is large in the vicinity. In a case where solely the millimeter-wave radar is used without using the LiDAR, the millimeter-wave radar cannot distinguish a target, such as the road surface unevenness or the small stone, with which the vehicle does not need to avoid collision, from a target, such as a rock, another vehicle, or a person, with which the vehicle needs to avoid collision, for example, having a height equal to or greater than a height that is predetermined. This is because the height resolution of the millimeter-wave radar is low. Therefore, when detection is solely based on the information about the target present in front of the vehicle detected by the millimeter-wave radar, there is a concern that the vehicle cannot be appropriately made to travel to avoid a collision with the obstacle.

In consideration of the above, the present disclosure provides an obstacle recognition device, an obstacle recognition method, and a storage medium storing a program that can distinguish a target with which a vehicle does not need to avoid collision from a target with which the vehicle needs to avoid collision based on information about the target present in front of the vehicle detected by a millimeter-wave radar.

(1) An aspect of the present disclosure relates to an obstacle recognition device including:

an acquisition unit configured to acquire information about a target present in front of a vehicle from a millimeter-wave radar mounted in the vehicle, the target being detected by the millimeter-wave radar;

a determination unit configured to execute, based on the information about the target acquired in the acquisition unit, a first determination that determines whether the target is present in a first area that is an area in which a distance from the vehicle traveling forward is less than a value that is predetermined, and a second determination that determines whether the target determined to be present in the first area in the first determination is detected by the millimeter-wave radar when the target is present in a second area that is an area in which the distance from the vehicle traveling forward is equal to or greater than the value that is predetermined; and

an output unit configured to discard the information about the target in a case where the target is determined to be present in the first area in the first determination and the target is determined to be not detected by the millimeter-wave radar when the target is present in the second area in the second determination, and output the information about the target in a case where the target is determined to be present in the first area in the first determination and the target is determined to be detected by the millimeter-wave radar when the target is present in the second area in the second determination.

(2) In the obstacle recognition device according to (1), the information about the target may include target position information and tracking information.

(3) In the obstacle recognition device according to (1), determination area information may be adjusted according to a usage environment of the vehicle, the determination area information being information in which the first area where the target corresponding to the information to be discarded by the output unit is presumed to be present is defined.

(4) An aspect of the present disclosure relates to an obstacle recognition method including:

acquiring, by an obstacle recognition device, information about a target present in front of a vehicle from a millimeter-wave radar mounted in the vehicle, the target being detected by the millimeter-wave radar;

executing, by the obstacle recognition device, based on the information about the target acquired in the acquiring, a first determination that determines whether the target is present in a first area that is an area in which a distance from the vehicle traveling forward is less than a value that is predetermined, and a second determination that determines whether the target determined to be present in the first area in the first determination is detected by the millimeter-wave radar when the target is present in a second area that is an area in which the distance from the vehicle traveling forward is equal to or greater than the value that is predetermined; and

discarding, by the obstacle recognition device, the information about the target in a case where the target is determined to be present in the first area in the first determination and the target is determined to be not detected by the millimeter-wave radar when the target is present in the second area in the second determination, and outputting, by the obstacle recognition device, the information about the target in a case where the target is determined to be present in the first area in the first determination and the target is determined to be detected by the millimeter-wave radar when the target is present in the second area in the second determination.

(5) An aspect of the present disclosure relates to a storage medium storing a program that causes a processor to execute:

acquiring information about a target present in front of a vehicle from a millimeter-wave radar mounted in the vehicle, the target being detected by the millimeter-wave radar;

executing, based on the information about the target acquired in the acquiring, a first determination that determines whether the target is present in a first area that is an area in which a distance from the vehicle traveling forward is less than a value that is predetermined, and a second determination that determines whether the target determined to be present in the first area in the first determination is detected by the millimeter-wave radar when the target is present in a second area that is an area in which the distance from the vehicle traveling forward is equal to or greater than the value that is predetermined; and

discarding the information about the target in a case where the target is determined to be present in the first area in the first determination and the target is determined to be not detected by the millimeter-wave radar when the target is present in the second area in the second determination, and outputting the information about the target in a case where the target is determined to be present in the first area in the first determination and the target is detected by the millimeter-wave radar when the target is present in the second area in the second determination.

According to the present disclosure, it is possible to distinguish the target with which the vehicle does not need to avoid collision from the target with which the vehicle needs to avoid collision based on the information about the target present in front of the vehicle detected by the millimeter-wave radar.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of a vehicle 1 to which an obstacle recognition device 15 of a first embodiment is applied;

FIG. 2 is a diagram showing an example of a flow of data in the vehicle 1 shown in FIG. 1;

FIG. 3 is a flowchart for describing an example of processing executed by the processor 153 of the obstacle recognition device 15 of the first embodiment;

FIG. 4A is a diagram for describing a specific example of the processing shown in FIG. 3; and

FIG. 4B is a diagram for describing a specific another example of the processing shown in FIG. 3.

### DETAILED DESCRIPTION OF EMBODIMENTS

Hereinafter, embodiments of an obstacle recognition device, an obstacle recognition method, and a program of the present disclosure will be described with reference to the drawings.

### First Embodiment

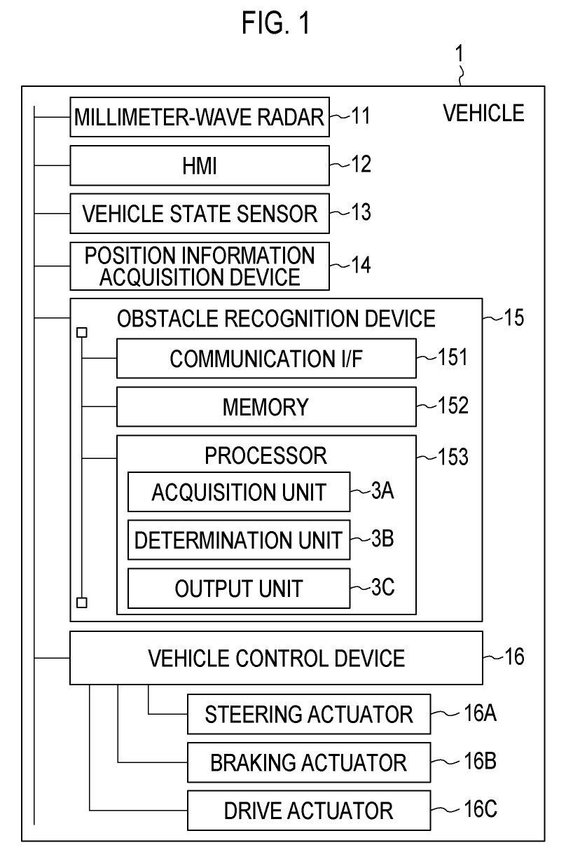

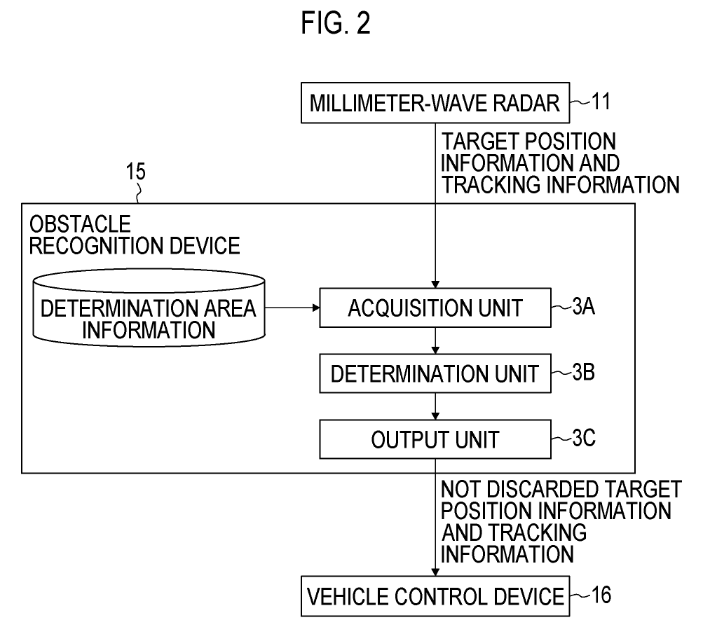

FIG. 1 is a diagram showing an example of a vehicle 1 to which an obstacle recognition device 15 of a first embodiment is applied. FIG. 2 is a diagram showing an example of a flow of data in the vehicle 1 shown in FIG. 1.

In the example shown in FIGS. 1 and 2, the vehicle 1 includes a millimeter-wave radar 11, a human machine interface (HMI) 12, a vehicle state sensor 13, a position information acquisition device 14, an obstacle recognition device 15, a vehicle control device 16, a steering actuator 16A, a braking actuator 16B, and a drive actuator 16C.

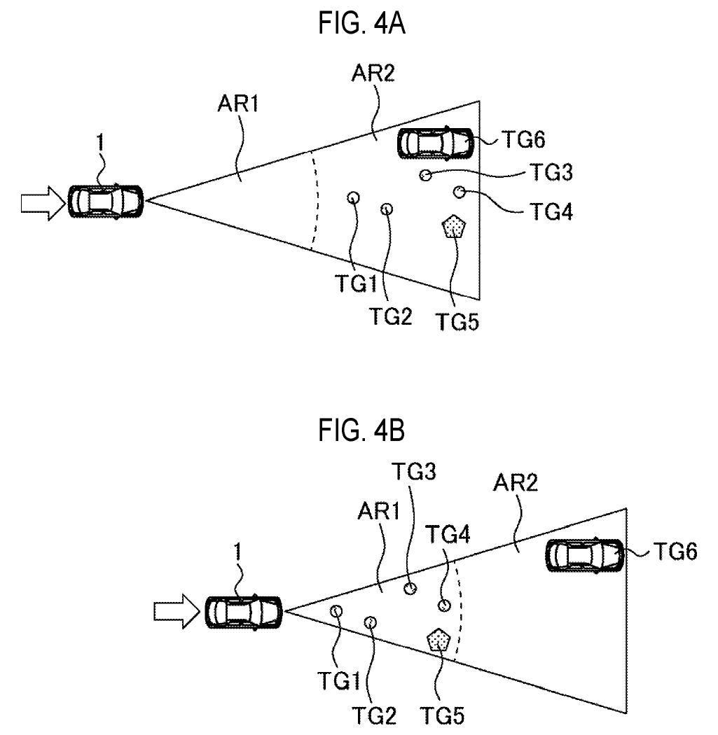

The millimeter-wave radar 11 is disposed in front or the like of the vehicle 1. The millimeter-wave radar 11 detects targets TG1 to TG6 (see FIGS. 4A and 4B) present in front of the vehicle 1, and transmits information (sensor data) on the targets TG1 to TG6 to the obstacle recognition device 15.

The present inventors have found out that the millimeter-wave radar 11 detects a large rock as the target TG5 (see FIGS. 4A and 4B) that the vehicle 1 needs to avoid collision (that is, the steering actuator 16A and the braking actuator 16B need to be controlled) while the vehicle 1 is traveling forward on the unpaved road. In addition, the present inventors have found that the other vehicle is detected as the target TG6 (see FIGS. 4A and 4B). The present inventors have found that the vehicle 1 detects small unevenness, the small stone, and the like on the road surface on which the vehicle 1 does not need to avoid collision as the targets TG1 to TG4 (see FIGS. 4A and 4B) (that is, receives reflection waves from the small unevenness, the small stone, and the like). That the vehicle 1 does not need to avoid the collision means that the steering actuator 16A and the braking actuator 16B do not need to be controlled. Further, the present inventors have found that when the small unevenness of the road surface, the small stone, and the like are present in the first area AR1 (see FIGS. 4A and 4B) that is an area at a distance of less than a value that is predetermined from the vehicle 1 traveling forward, the small unevenness of the road surface, the small stone, and the like are detected by the millimeter-wave radar 11 as the targets TG1 to TG4. In addition, the present inventors have found that when the small unevenness of the road surface, the small stone, and the like are present in the second area AR2 (see FIGS. 4A and 4B) that is an area at a distance from the vehicle 1 traveling forward equal to or greater than a value that is predetermined, the small unevenness of the road surface, the small stone, and the like are not detected by the millimeter-wave radar 11 as the targets TG1 to TG4. The first area is an area near the vehicle 1, and the second area is an area far from the vehicle 1. Therefore, in the examples shown in FIGS. 1 and 2, a measure described below is taken to distinguish the targets TG1 to TG4 with which the vehicle does not need to avoid collision and the target TG5, TG6 with which the vehicle 1 needs to avoid a collision.

In the example shown in FIGS. 1 and 2, the HMI 12 has a function of receiving various operations of the user of the vehicle 1 and transmits a signal indicating the operation of the user of the vehicle 1 to the vehicle control device 16 and the like. Examples of the operation of the user of the vehicle 1 received by the HMI 12 include an operation of executing autonomous driving of the vehicle 1 by the vehicle control device 16, and an operation of switching autonomous driving of the vehicle 1 to manual driving. The vehicle state sensor 13 includes, for example, a vehicle speed sensor.

The vehicle state sensor 13 transmits information indicating the state of the vehicle 1 (for example, the vehicle speed) to the obstacle recognition device 15, the vehicle control device 16, and the like.

The position information acquisition device 14 acquires information indicating the position of the vehicle 1. The position information acquisition device 14 includes, for example, a global positioning system (GPS) device that measures the position of the vehicle 1. The position information acquisition device 14 may perform a well-known self-position estimation process (localization) to increase the accuracy of the information indicating the position of the vehicle 1. The position information acquisition device 14 transmits information indicating the position of the vehicle 1 to the obstacle recognition device 15, the vehicle control device 16, and the like.

The vehicle control device 16 is constituted by, for example, a vehicle control electronic control unit (ECU). The vehicle control device 16 controls the steering actuator 16A, the braking actuator 16B, and the drive actuator 16C based on information (signal) transmitted from, for example, the HMI 12, the vehicle state sensor 13, the position information acquisition device 14, the obstacle recognition device 15, or the like. The vehicle control device 16 has a function of executing autonomous driving of the vehicle 1.

The obstacle recognition device 15 is configured by a microcomputer including a communication interface (I/F) 151, a memory 152, and a processor 153.

The communication interface 151 has an interface circuit for connecting the obstacle recognition device 15 to the millimeter-wave radar 11, the HMI 12, the vehicle state sensor 13, the position information acquisition device 14, the vehicle control device 16, and the like. The memory 152 (storage medium) stores a program and various types of data used in processing executed by the processor 153. The data stored in the memory 152 includes, for example, determination area information (see FIG. 2). The determination area information is information in which a parameter (for example, size) related to the first area AR1 (see FIGS. 4A and 4B) in which the targets TG1 to TG4 (road surface unnecessary targets) with which the vehicle 1 does not need to avoid collision can be present is defined. A range in which the millimeter-wave radar 11 detects the targets TG1 to TG4 (road surface unnecessary targets (for example, small unevenness of an unpaved road, small stones)) with which the vehicle 1 does not need to avoid a collision is different depending on a state or a material of a road surface on which the vehicle 1 travels. Therefore, the parameter related to the first area AR1 is adjusted, for example, by a user of the vehicle 1 according to the usage environment of the vehicle 1. That is, the memory 152 stores, for example, the determination area information adjusted according to the usage environment of the vehicle 1 by the user of the vehicle 1.

The processor 153 has a function as an acquisition unit 3A, a function as a determination unit 3B, and a function as an output unit 3C.

The acquisition unit 3A acquires information (more specifically, time-series data) on the targets TG1 to TG6 (see FIGS. 4A and 4B) present in front of the vehicle 1 detected by the millimeter-wave radar 11 from the millimeter-wave radar 11. The information about the targets TG1 to TG6 includes the target position information (information indicating the relative positions of the targets TG1 to TG6 with respect to the vehicle 1) and the tracking information. The tracking information is information that can distinguish whether the targets TG1 to TG6 output from the millimeter-wave radar 11 in time series are the same or not. In the example shown in FIGS. 4A and 4B described below, it is possible to recognize that each of the targets TG5, TG6 detected by the millimeter-wave radar 11 at the past point in time shown in FIG. 4A and each of the targets TG5, TG6 detected by the millimeter-wave radar 11 at the current point in time shown in FIG. 4B are the same. The recognition is performed based on the tracking information output from the millimeter-wave radar 11.

The determination unit 3B executes determination (first determination) as to whether the target TG1 to the target TG6 is present in the first area AR1 (see FIG. 4B) based on the information about the targets TG1 to TG6 (see FIG. 4B) acquired by the acquisition unit 3A. Further, the determination unit 3B executes a determination (second determination) as to whether the targets TG1 to TG5 (see FIG. 4B) determined to be present in the first area AR1 (see FIG. 4B) in the first determination are detected by the millimeter-wave radar 11 when the targets TG1 to TG5 are present in the second area AR2 (see FIG. 4A). The determination is made based on information about the targets TG1 to TG6 (see FIGS. 4A and 4B) acquired by the acquisition unit 3A.

The output unit 3C discards the information about the targets TG1 to TG4. The process is executed in a case where the determination unit 3B determines that the targets TG1 to TG4 (see FIG. 4B) are present in the first area AR1 (see FIG. 4B) in the first determination executed by the determination unit 3B, and the determination unit 3B determines that the targets TG1 to TG4 (see FIG. 4A) are present in the second area AR2 (see FIG. 4A) in the second determination executed by the determination unit 3B, and the targets TG1 to TG4 are not detected by the millimeter-wave radar 11. In addition, the output unit 3C outputs the information about the target TG5 to the vehicle control device 16. The process is executed in a case where the determination unit 3B determines that the target TG5 (see FIG. 4B) is present in the first area AR1 (see FIG. 4B) in the first determination executed by the determination unit 3B, and the determination unit 3B determines that the target TG5 (see FIG. 4A) is present in the second area AR2 (see FIG. 4A) in the second determination executed by the determination unit 3B, and the target TG5 is detected by the millimeter-wave radar 11.

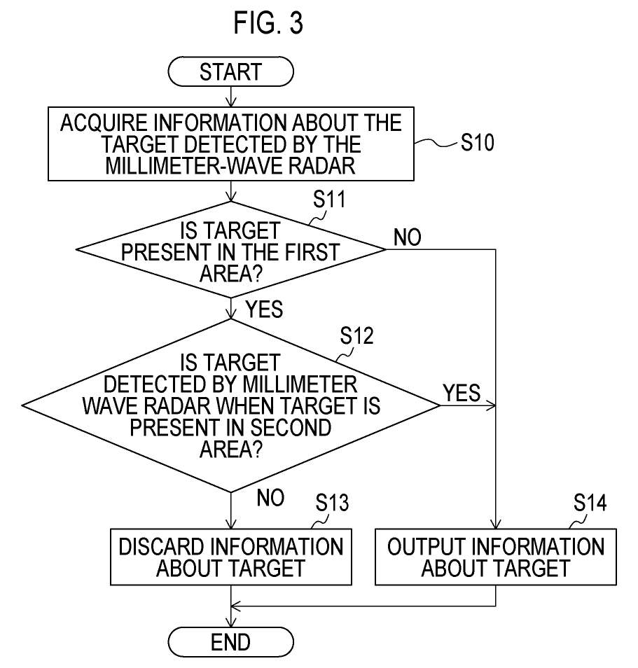

FIG. 3 is a flowchart for describing an example of processing executed by the processor 153 of the obstacle recognition device 15 of the first embodiment.

The process shown in FIG. 3 is executed, for example, while the vehicle 1 is traveling (in detail, traveling forward).

In the example shown in FIG. 3, in S10, the acquisition unit 3A acquires information (time-series data) on the target present in front of the vehicle 1 detected by the millimeter-wave radar 11 from the millimeter-wave radar 11.

In S11, the determination unit 3B executes a determination as to whether the target is present in the first area AR1 (see FIG. 4B) based on the information about the target acquired in S10 (specifically, the current point in time data in the time-series data) (first determination). When the determination in S10 is YES, the process proceeds to S12, and when the determination in S10 is NO, the process proceeds to S14.

In S12, the determination unit 3B executes a determination as to whether the target determined to be present in the first area AR1 in S11 is present in the second area AR2 (see FIG. 4A) based on the information about the target acquired in S10, is detected by the millimeter-wave radar 11 (second determination). The information about the target acquired in S10 is, in detail, time-series data including data at the current point in time and data at a point in time in the past from the current point in time. When the determination in S12 is YES, the process proceeds to S14, and when the determination in S12 is NO, the process proceeds to S13.

In S13, the output unit 3C discards the information about the target.

In S14, the output unit 3C outputs the information about the target to the vehicle control device 16.

FIGS. 4A and 4B are diagrams for describing specific examples of the processing shown in FIG. 3. Specifically, FIG. 4A shows an example of the positional relationship between the vehicle 1, the targets TG1 to TG6, and the first area AR1 and the second area AR2 at a past point in time. FIG. 4B shows an example of the positional relationship between the vehicle 1, the targets TG1 to TG6, and the first area AR1 and the second area AR2 at the current point in time.

In the example shown in FIGS. 4A and 4B, in S10 of FIG. 3, the acquisition unit 3A acquires from the millimeter-wave radar 11 the time-series data of the targets TG1 to TG6 detected by the millimeter-wave radar 11 from, for example, the past point in time shown in FIG. 4A to the current point in time shown in FIG. 4B. The data is acquired as information about the targets TG1 to TG6 present in front of the vehicle 1 detected by the millimeter-wave radar 11.

In S11 of FIG. 3, the determination unit 3B determines that the targets TG1 to TG5 are present in the first area AR1 based on the data of the targets TG1 to TG6 detected by the millimeter-wave radar 11 at the current point in time shown in FIG. 4B among the time-series data acquired in S10. In addition, the determination unit 3B determines that the target TG6 (another vehicle) is not present in the first area AR1.

In the example shown in FIGS. 4A and 4B, at the current point in time shown in FIG. 4B, there is no possibility that the vehicle 1 and the target TG6 (another vehicle) collide with each other. In addition, there is no need to execute unnecessary control of the steering actuator 16A or the braking actuator 16B to avoid the collision between the vehicle 1 and the target TG6. Therefore, in S14 of FIG. 3, the information about the target TG6 is output to the vehicle control device 16 without being discarded.

In addition, in the examples shown in FIGS. 4A and 4B, in S12 of FIG. 3, the determination unit 3B determines that the target TG5 (large rock) determined to be present in the first area AR1 at the current point in time shown in FIG. 4B is detected by the millimeter-wave radar 11 even at the past point in time shown in FIG. 4A when the target TG5 is present in the second area AR2. The determination is made based on the time-series data of the targets TG1 to TG6 detected by the millimeter-wave radar 11 from the past point in time shown in FIG. 4A acquired in S10 to the current point in time shown in FIG. 4B.

In the example shown in FIG. 4, at the current point of time shown in FIG. 4B, there is a possibility that the vehicle 1 and the target TG5 (large rock) collide with each other. Therefore, the control of the steering actuator 16A and/or the braking actuator 16B is needed to avoid the collision between the vehicle 1 and the target TG5. Therefore, in S14 of FIG. 3, the information about the target TG5 is output to the vehicle control device 16 without being discarded.

The vehicle control device 16 executes control to operate the steering actuator 16A and/or the braking actuator 16B based on the information about the target TG5 output from the output unit 3C in order to avoid the collision between the vehicle 1 and the target TG5.

On the other hand, in the example shown in FIGS. 4A and 4B, in S12 of FIG. 3, the determination unit 3B determines that the targets TG1 to TG4 determined to be present in the first area AR1 at the current point in time shown in FIG. 4B are not detected by the millimeter-wave radar 11 at the past point in time shown in FIG. 4A when the targets TG1 to TG4 are present in the second area AR2. The determination is made based on the time-series data of the targets TG1 to TG6 detected by the millimeter-wave radar 11 from the past point in time shown in FIG. 4A acquired in S10 to the current point in time shown in FIG. 4B. The targets TG1 to TG4 are the small unevenness, the small stone, and the like on the road surface of the unpaved road. That is, the determination unit 3B determines that the targets TG1 to TG4 present in the first area AR1 at the current point in time are the small unevenness, the small stone, and the like on the road surface of the unpaved road, and that there is no need to avoid collision between the vehicle 1 and the targets TG1 to TG4.

That is, in the examples shown in FIGS. 4A and 4B, the control of the steering actuator 16A and/or the braking actuator 16B is not needed to avoid the collision between the vehicle 1 and the targets TG1 to TG4. Therefore, the information about the targets TG1 to TG4 is discarded in S13 of FIG. 3 and is not output to the vehicle control device 16.

As a result, the vehicle control device 16 does not execute the unnecessary control for operating the steering actuator 16A and/or the braking actuator 16B to avoid the collision between the vehicle 1 and the targets TG1 to TG4.

That is, as shown in FIG. 4B, while the vehicle 1 travels (travels forward) on the unpaved road, the millimeter-wave radar 11 receives the reflection waves from the small unevenness, the small stone, and the like (from the target TG1 to the target TG4) on the road surface in the vicinity of the vehicle 1, and the targets TG1 to TG4 are detected. The vicinity of the vehicle 1, that is, the vicinity of the vehicle 1 is within the first area AR1.

As shown in FIG. 4B, it is needed to distinguish and recognize a large rock (target TG5) near the vehicle 1 that needs to avoid a collision with the vehicle 1 and a small unevenness on the road surface, a small stone, and the like (targets TG1 to TG4) that need not avoid a collision with the vehicle 1. The vicinity of the vehicle 1, that is, the vicinity of the vehicle 1 is within the first area AR1.

Therefore, in the examples shown in FIGS. 4A and 4B, the small unevenness of the road surface, the small stone, and the like (the targets TG1 to TG4) are present in the first area AR1 that is an area at a distance of less than a value that is predetermined from the vehicle 1 traveling forward, the small unevenness of the road surface, the small stone, and the like are detected by the millimeter-wave radar 11. However, the characteristic that is not detected by the millimeter-wave radar 11 when the distance from the vehicle 1 traveling forward is present in the second area AR2 of the value that is predetermined or more and the tracking information are used.

As a result, the large rock (target TG5) in the vicinity of the vehicle 1 that needs to avoid the collision with the vehicle 1 and the small unevenness, the small stone, and the like (targets TG1 to TG4) on the road surface that does not need to avoid the collision with the vehicle 1 can be distinguished and recognized. The vicinity of the vehicle 1, that is, the vicinity of the vehicle 1 is within the first area AR1.

### Second Embodiment

The obstacle recognition device 15 of the second embodiment is configured in the same manner as the obstacle recognition device 15 of the first embodiment described above, except for the following points.

As described above, the obstacle recognition device 15 of the first embodiment is provided in the vehicle 1.

On the other hand, the obstacle recognition device 15 of the second embodiment may be disposed outside the vehicle 1, such as a controller that controls traveling of the vehicle 1.

### Third Embodiment

The vehicle 1 to which the obstacle recognition device 15 of the third embodiment is applied is configured in the same manner as the vehicle 1 to which the obstacle recognition device 15 of the first embodiment is applied, except for the following points.

As described above, in the vehicle 1 (autonomous driving vehicle) to which the obstacle recognition device 15 of the first embodiment is applied, the vehicle control device 16 executes the control to operate the steering actuator 16A and/or the braking actuator 16B to avoid the collision between the vehicle 1 and the target TG5. The control is performed based on the information about the target TG5 output from the output unit 3C.

On the other hand, in the vehicle 1 to which the obstacle recognition device 15 of the third embodiment is applied, the warning indicating that the operation for avoiding the collision between the vehicle 1 and the target TG5 is needed is output to the HMI 12. The output is performed by the vehicle control device 16 based on the information about the target TG5 output from the output unit 3C.

As described above, the embodiments of the obstacle recognition device, the obstacle recognition method, and the program of the present disclosure have been described with reference to the drawings. However, the obstacle recognition device, the obstacle recognition method, and the program according to the present disclosure are not limited to the above-described embodiments, and can be appropriately changed within the scope without departing from the spirit of the present disclosure. The configurations of each of the examples of the above-described embodiments may be appropriately combined. In each of the examples of the above-described embodiments, the processing executed by the obstacle recognition device 15 has been described as software processing executed by a program. However, the processing executed by the obstacle recognition device 15 may be processing executed by hardware. Alternatively, the processing executed by the obstacle recognition device 15 may be processing in which both software and hardware are combined. The program stored in the memory 152 of the obstacle recognition device 15 may be recorded in a computer-readable recording medium, such as a semiconductor memory, a magnetic recording medium, or an optical recording medium, and provided, distributed, or the like. The program is a program that realizes the function of the processor 153 of the obstacle recognition device 15.

What is claimed is:

1. An obstacle recognition device comprising:
an acquisition unit configured to acquire information about a target present in front of a vehicle from a millimeter-wave radar mounted in the vehicle, the target being detected by the millimeter-wave radar;
a determination unit configured to execute, based on the information about the target acquired by the acquisition unit, a first determination that determines whether the target is present in a first area that is an area in which a distance from the vehicle traveling forward is less than a value that is predetermined, and a second determination that determines whether the target determined to be present in the first area in the first determination is detected by the millimeter-wave radar when the target is present in a second area that is an area in which the distance from the vehicle traveling forward is equal to or greater than the value that is predetermined; and
an output unit configured to discard the information about the target in a case where the target is determined to be present in the first area in the first determination and the target is determined to be not detected by the millimeter-wave radar when the target is present in the second area in the second determination, and output the information about the target in a case where the target is determined to be present in the first area in the first determination and the target is determined to be detected by the millimeter-wave radar when the target is present in the second area in the second determination.

2. The obstacle recognition device according to claim 1, wherein the information about the target includes target position information and tracking information.

3. The obstacle recognition device according to claim 1, wherein determination area information is adjusted according to a usage environment of the vehicle, the determination area information being information in which the first area where the target corresponding to the information to be discarded by the output unit is presumed to be present is defined.

4. An obstacle recognition method comprising:
acquiring, by an obstacle recognition device, information about a target present in front of a vehicle from a millimeter-wave radar mounted in the vehicle, the target being detected by the millimeter-wave radar;
executing, by the obstacle recognition device, based on the information about the target acquired in the acquiring, a first determination that determines whether the target is present in a first area that is an area in which a distance from the vehicle traveling forward is less than a value that is predetermined, and a second determination that determines whether the target determined to be present in the first area in the first determination is detected by the millimeter-wave radar when the target is present in a second area that is an area in which the distance from the vehicle traveling forward is equal to or greater than the value that is predetermined; and
discarding, by the obstacle recognition device, the information about the target in a case where the target is determined to be present in the first area in the first determination and the target is determined to be not detected by the millimeter-wave radar when the target is present in the second area in the second determination, and outputting, by the obstacle recognition device, the information about the target in a case where the target is determined to be present in the first area in the first determination and the target is determined to be detected by the millimeter-wave radar when the target is present in the second area in the second determination.

5. A non-transitory storage medium storing a program that causes a processor to execute:
acquiring information about a target present in front of a vehicle from a millimeter-wave radar mounted in the vehicle, the target being detected by the millimeter-wave radar;
executing, based on the information about the target acquired in the acquiring, a first determination that determines whether the target is present in a first area that is an area in which a distance from the vehicle traveling forward is less than a value that is predetermined, and a second determination that determines whether the target determined to be present in the first area in the first determination is detected by the millimeter-wave radar when the target is present in a second area that is an area in which the distance from the vehicle traveling forward is equal to or greater than the value that is predetermined; and
discarding the information about the target in a case where the target is determined to be present in the first area in the first determination and the target is determined to be not detected by the millimeter-wave radar when the target is present in the second area in the second determination, and outputting the information about the target in a case where the target is determined to be present in the first area in the first determination and the target is detected by the millimeter-wave radar when the target is present in the second area in the second determination.
